(19) United States
(12) Patent Application Publication
(10) Pub. No.: US 2016/0159070 A1
(43) Pub. Date: Jun. 9, 2016

(54) MICROBE-BASED MASTERS FOR MICRO CONTACT PRINTING AND METHODS FOR THEIR PREPARATION AND USE

(71) Applicant: INDIAN INSTITUTE OF TECHNOLOGY KANPUR, Kanpur, Uttar Pradesh (IN)

(72) Inventors: Deepak GUPTA, Kanpur, Uttar Pradesh (IN); Balaji PRAKASH, Mysore, Karnataka (IN); Sunita MEHTA, Kanpur, Uttar Pradesh (IN); Saravanan MURUGESON, Chennai, Tamilnadu (IN)

(21) Appl. No.: 14/891,813

(22) PCT Filed: Mar. 14, 2014
(86) PCT No.: PCT/IB14/59776

§ 371 Date: Nov. 17, 2015

(30) Foreign Application Priority Data
May 17, 2013 (IN) 1468/DEL/2013

(51) Int. Cl. B41C 1/10

(52) U.S. Cl. CPC B41C 1/10

(57) ABSTRACT

A master used for micro contact printing and methods of creating thereof are disclosed. The master may include a permeable membrane removed from a surface of a media plate having one or more microbial nutrients. The master may also include a plurality of microbes positioned upon at least a portion of the permeable membrane. The microbes may be grown in a vertical direction to form a patterned surface.

### CROSS-REFERENCE TO RELATED APPLICATIONS

This application claims priority from Indian Patent Application Serial No. 1468/DEL/2013, filed May 17, 2013, and titled “MICROBE-BASED MASTERS FOR MICRO CONTACT PRINTING AD METHODS FOR THEIR PREPARATION AND USE”, the contents of which are incorporated herein in their entirety.

### BACKGROUND

Micro contact printing is a versatile technique for fabricating nanostructures, and as a result has enjoyed widespread use. Micro contact printing may require a master, which is then used to create a stamp through the use of replica molding of an intermediate die. As a result, nanopatterns on the master can be replicated an infinite number of times on a stamp.

Lithographic techniques involved in the fabrication of the master may use patterned chrome plates and/or a mask, either of which can be expensive. Further, the lithography process and subsequent chemical etching can be time-consuming. Previous attempts to reduce the time and cost involved with the lithography process have not been successful in dramatically reducing the time and cost.

### SUMMARY

In an embodiment, a method of creating a master for micro contact printing may include depositing a permeable membrane on a surface of a media plate comprising one or more microbial nutrients and depositing a plurality of microbes upon the permeable membrane. The plurality of microbes may be configured to grow away from the permeable membrane in a vertical direction to form a patterned surface.

In an embodiment, a method of creating a master for micro contact printing may include depositing a permeable membrane on a surface of a media plate having one or more microbial nutrients treating at least a portion of the permeable membrane with one or more of a pore blocking agent and an antimicrobial agent, and treating at least a portion of the permeable membrane with a mixture that includes a plurality of microbes. The one or more of the pore blocking agent and the antimicrobial agent may be selectively placed upon the permeable membrane in a desired pattern and the plurality of microbes may be configured to grow away from the permeable membrane in a vertical direction in the regions where the one or more of the pore blocking agent and the antimicrobial agent are not present to form a patterned surface.

In an embodiment, a method of creating a master for micro contact printing may include cutting a desired pattern on an impermeable thin sheet, placing the impermeable thin sheet on a surface of a media plate having one or more microbial nutrients, and depositing a mixture that includes a plurality of microbes on the impermeable thin sheet. The plurality of microbes may be configured to grow away from the surface of the media plate in a vertical direction through the patterned cuts in the impermeable thin sheet to form a patterned surface.

In an embodiment, a master used for micro contact printing may include a permeable membrane removed from a surface of a media plate having one or more microbial nutrients and a plurality of microbes positioned upon at least a portion of the permeable membrane. The microbes may be grown in a vertical direction to form a patterned surface.

### BRIEF DESCRIPTION OF THE DRAWINGS

FIG. 1 depicts a perspective view of a master plated on a media plate having a nutrient media according to an embodiment.

FIG. 2 depicts a detailed view of the master of FIG. 1 according to an embodiment.

FIG. 3 depicts a flow diagram of a method for creating a master according to an embodiment.

FIG. 4 depicts a flow diagram of an alternative method for creating a master according to an embodiment.

FIG. 5 depicts a flow diagram of another alternative method for creating a master according to an embodiment.

FIGS. 6a and 6b depict images of E. coli growth on a surfactant-treated medium according to an embodiment.

FIG. 7 depicts optical images of a yeast culture suspension according to an embodiment.

FIG. 8 depicts optical images of a PDMS stamp and a gold pattern printed on a substrate according to an embodiment.

FIGS. 9a and 9b depict cuts and growth of a yeast culture on a Rubylith sheet according to an embodiment.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The present disclosure relates generally to the creation of one or more masters to be used as a template for micro contact printing, lithographic replication techniques, and the like. More particularly, the present disclosure relates to methods of creating masters using microbes to form the intricate patterns required for micro contact printing, which may be done more accurately and at a lower cost than more traditional methods of creating a master.

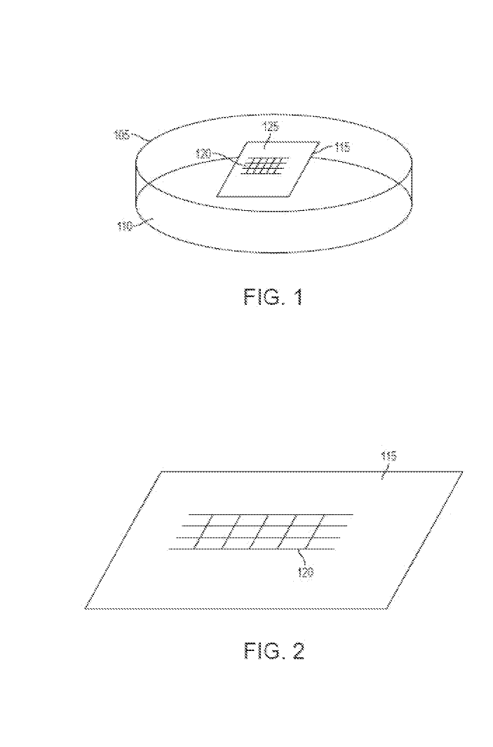

FIGS. 1 and 2 depict a master 115 plated on a media plate 105 having a nutrient media 110 according to an embodiment. In various embodiments, the master 115 may be used for micro contact printing and/or the like. In particular embodiments, the master 115 may be used to create a patterned surface using any lithographic process now known or later developed, as described in greater detail herein. In some embodiments, multiple masters 115 can be made concurrently and can be incubated next to each other, as described in greater detail herein. In some embodiments, the master 115 may have one or more features that can be used for micro contact printing. The one or more features may have an average width of about 200 to about 300 microns and an average height of about 10 to about 1000 microns.

In various embodiments, the master 115 may include at least a permeable membrane 125 and a plurality of microbes 120. In some embodiments, the master 115, when plated on the media plate 105 as described in greater detail herein, may allow for the plurality of microbes 120 to grow in a substantially vertical direction upon the master in a pattern. In some embodiments, the pattern of the growth of the plurality of microbes 120 may depend on the addition of additives such as surfactants, antimicrobial agents, pore blocking agents, use of impermeable membranes, and/or the like, as described in greater detail herein.

In various embodiments, the permeable membrane 125 may provide a suitable substrate upon which the plurality of microbes 120 can grow, particularly because the microbes, once they have sufficiently grown on the membrane, may easily be lifted off from the nutrient media 110. In some embodiments, the permeable membrane 125 may be any type of membrane that is porous and can support microbial growth thereon and/or therethrough. Specific examples of suitable permeable membranes may include polyvinylidene fluoride, regenerated cellulose, nitrocellulose, cellophane, polymethylmethacrylate, nylon, cellulose acetate, cellulose ester, benzoylated cellulose, and polysulphone. The pore size of the permeable membrane 125 is not limited by this disclosure. Average pore sizes of the permeable membrane 125 may be about 3 kDa to about 100 kDa. Specific examples may include about 3 kDa, about 5 kDa, about 10 kDa, about 25 kDa, about 50 kDa, about 75 kDa, about 100 kDa, or any range or value between any two of these values.

In various embodiments, the plurality of microbes 120 may include any type of cell that can be cultured on the media plate 105. Furthermore, the plurality of microbes 120 may include one or more different varieties of culturable cells. The type of culturable cell is not limited by this disclosure, and may include any culturable cell now known or later discovered. Specific examples of culturable cells may include an adherent cell, a neoplastic cell, a neuronal cell, a microglia cell, a giant cell, a hormone secreting cell, a metabolism cell, a storage cell, a barrier function cell, an extracellular matrix-secreting cell, a contractile cell, a blood and immune system cell, a germ cell, a stem cell, a fused cell, a primary cell, a cell line, a bacterial cell, a yeast, a protist, and the like. In particular embodiments, the plurality of microbes may be one or more of Escherichia coli, Saccharomyces cerevisiae, Saccharomyces exiguus, a biofilm bacterium, and the like.

In various embodiments, the plurality of microbes 120 may grow to an average height of about 10 microns to about 1000 microns from a surface of the permeable membrane 115 and/or an impermeable thin sheet. Specific examples of the average height may be about 10 microns, about 50 microns, about 100 microns, about 250 microns, about 500 microns, about 750 microns, about 1000 microns, or any value or range between any two of these values.

In some embodiments, the plurality of microbes 120 may grow in a stable formation, where they are capable of holding the pattern in which they grow that is used to complete additional steps in the lithographic process. In other embodiments, the plurality of microbes 120 may grow in an unstable formation, where they are incapable of holding the pattern in which they grow that is used to complete additional steps in the lithographic process. To adjust for this unstable formation, the plurality of microbes 120 may be combined with one or more dimensional stability elements positioned upon the patterned surface of the plurality of microbes 120. Specific examples of dimensional stability elements that may be suitable for providing stability to the plurality of microbes 120 may include aluminum oxide, silicon oxide, silicon nitride, and the like.

In various embodiments, the growth of the plurality of microbes 120 may be assisted and/or promoted by the application of one or more surfactants. In some embodiments, the plurality of microbes 120 may be configured to only grow in areas that are coated with the one or more surfactants. In some embodiments, the surfactants may be coated over the entirety of the permeable membrane 125. In other embodiments, only a portion of the permeable membrane 125 and/or the media plate 105 may be coated with the one or more surfactants. In particular embodiments, the permeable membrane 125 may only be coated with the one or more surfactants in the areas in which growth of the plurality of microbes 120 is desired. Thus, the one or more surfactants may be placed in a specific pattern upon the permeable membrane 125 and/or the media plate 105, as discussed in greater detail herein. The type of surfactant is not limited by this disclosure, and may include any surfactants now known or later developed. Specific examples of surfactants may include a nonionic surfactant, an anionic surfactant, a cationic surfactant, a zwitterionic surfactant, a polysorbate surfactant Tween®-20 (Thermo Fisher Scientific, Rockford, Ill.), Triton™ X-100 (Dow Chemical Company, Midland, Mich.), combinations thereof, and the like.

In various embodiments, the growth of the plurality of microbes 120 may be hindered and/or restricted by the application of a pore blocking agent and/or an antimicrobial agent. In some embodiments, the plurality of microbes 120 may be configured to only grow in areas that are not coated with the pore blocking agent and/or the antimicrobial agent. In some embodiments, the pore blocking agent and/or the antimicrobial agent may be coated over a portion of the permeable membrane 125 and/or a portion of the media plate 105. In particular embodiments, the permeable membrane 125 may only be coated with the pore blocking agent and/or the antimicrobial agent in the areas in which growth of the plurality of microbes 120 is not desired. Thus, the pore blocking agent and/or the antimicrobial agent may be placed in a specific pattern upon the permeable membrane 125 and/or the media plate 105, as discussed in greater detail herein. The type of pore blocking agent is not limited by this disclosure, and may include any pore blocking agents now known or later developed that are configured to block the pores of the permeable membrane 125 to inhibit growth of the plurality of microbes 120 thereon. Specific examples of pore blocking agents may include an epoxy adhesive, an acrylic adhesive, a polyurethane adhesive, a particulate mixture in a solution, a colloidal solution, a paint emulsion, and the like. Likewise, the type of antimicrobial agent is not limited by this disclosure, and may include any antimicrobial agents now known or later developed that are configured to inhibit and/or kill at least a portion of the plurality of microbes 120 that come in contact with the antimicrobial agent. Specific examples of antimicrobial agents may include an antimicrobial compound, an antimicrobial peptide, an antimicrobial enzyme, an antibiotic, benzalkonium chloride, benzethonium chloride, benzyl alcohol, cetylpyridinium chloride, chlorobutanol, phenol, phenylethyl alcohol, phenylmercuric nitrate, a metallic silver, a silver compound, a solution of silver nanoparticles, iodine, polyhexamethylene biguanide, acetic acid, chlorhexidine, an aminoglycoside, an ansamycin, carbacephem, a cephalosporin, a glycopeptide, a macroliden, a monobactam, a sulfonamide, and the like.

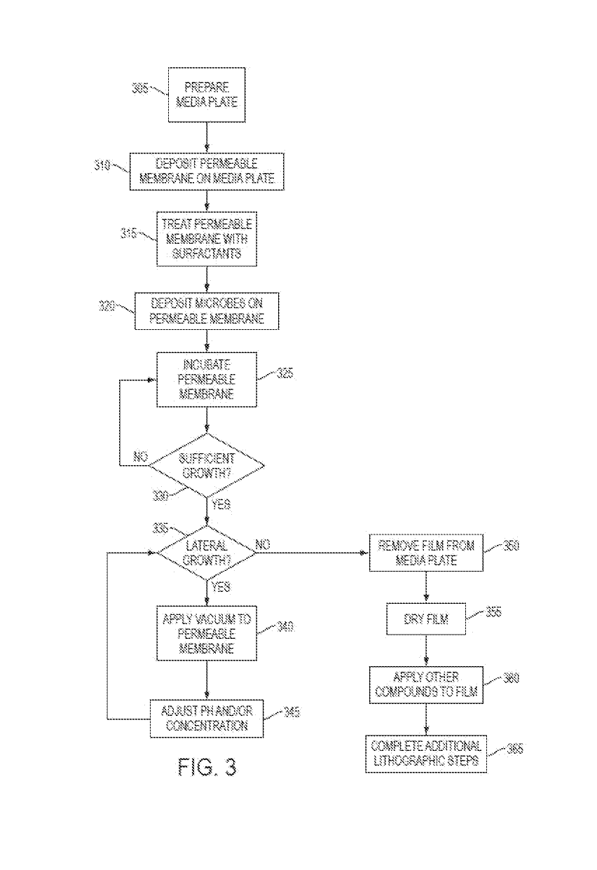

FIG. 3 depicts a flow diagram of a method for creating a master according to an embodiment. The method described herein is merely illustrative; additional, fewer, and/or alternative method steps are contemplated without departing from the scope of the present disclosure. The methods described herein will be described with respect to a user; however, more than one user and/or one or more machines may also conduct the methods.

In various embodiments, the user may provide or prepare 305 a media plate. The media plate may be prepared by any method now known or later developed for preparing media plates. In some embodiments, the media plate may contain nutrient media having one or more microbial nutrients. Illustrative examples of nutrient media may include agar media, preservation culture media, enrichment culture media, selective culture media, differential culture media, resuscitation culture media, general purpose media, isolation culture media, and fermentation media. Specific examples of the nutrient media may include Luria-Bertani (LB) media, Yeast-Peptone-Dextrose (YPD) media, de Man-Rogosa-Sharpe (MRS) media, and/or the like.

In various embodiments, the user may deposit 310 the permeable membrane on the media plate. Deposition 310 of the permeable membrane may be completed by any method of deposition now known or later developed. In various embodiments, the user may treat 315 the membrane with one or more surfactants. In some embodiments, the user may treat 315 the entire membrane with the one or more surfactants. In other embodiments, the user may treat 315 only a portion of the membrane with the one or more surfactants. In particular embodiments, the user may treat 315 the portion of the membrane at which microbial growth is desired with the one or more surfactants.

In various embodiments, the user may deposit 320 the microbes on the permeable membrane. In some embodiments, the microbes may be deposited 320 over the entire permeable membrane. In other embodiments, the microbes may be deposited 320 over a portion of the permeable membrane. In particular embodiments, the microbes may be deposited 320 on the portion of the permeable membrane at which microbial growth is desired. In some embodiments, the microbes may be deposited 320 on portions of the permeable membrane that have been treated with the one or more surfactants. Deposition 320 in any one of these manners may cause the microbes to grow in a desired pattern upon the permeable membrane.

In some embodiments in which the one or more surfactants are used, the user may treat 315 the permeable membrane with the one or more surfactants and deposit 320 the microbes at substantially the same time. In some embodiments, a mixture containing at least both the microbes and the one or more surfactants may be used for the combined treating 315 and deposition 320.

In various embodiments, deposition 310 of the one or more microbes and/or deposition 320 of the one or more surfactants may be completed with the use of a printer, such as, for example, an inkjet printer, a screen printer, an off-set printer, and a precision materials deposition printer. The printer may be provided with an ink formulation that contains at least the one or more microbes and/or the one or more surfactants. In some embodiments, the ink formulation may exhibit a surface tension of about 10 mN/m to about 50 mN/m. Specific examples of surface tension exhibited by the ink formulation may include about 10 mN/M, about 15 mN/m, about 20 mN/m, about 25 mN/m, about 30 mN/m, about 40 mN/m, about 50 mN/m, or any value or range between any two of these values. In some embodiments, the ink formulation may have a viscosity of about 1 cP to about 25 cP. Specific examples of the viscosity may include about 1 cP, about 5 cP, about 8 cP, about 10 cP, about 12 cP, about 15 cP, about 20 cP, about 25 cP, or any value or range between any two of these values.

In various embodiments, the user may incubate 325 the plated combination to allow the microbes to grow upon the media and/or the permeable membrane. Incubation 325 is not limited by this disclosure, and may include any incubation process now known or later developed. In some embodiments, the plated combination may be incubated 325 at a specific temperature, a specific humidity, a period of time, and/or at varying light/dark periods. For example, the temperature may be 37° C., the humidity may be about 45% to about 55%, and the time period may be about 1 hour to about 48 hours.

In various embodiments, the user may determine 330 whether sufficient growth of microbes has occurred. In some embodiments, sufficient growth may be determined 330 after a period of time has elapsed. In some embodiments, sufficient growth may be determined 330 once the microbes have achieved a sufficient dimensional growth. For example, sufficient growth may be determined 330 once the microbes have grown to a threshold average height. In some embodiments, the threshold average height may be about 10 microns to about 1000 microns from a surface of the permeable membrane. Specific examples of a threshold average height may be about 10 microns, about 50 microns, about 100 microns, about 250 microns, about 500 microns, about 750 microns, about 1000 microns, or any value or range between any two of these values. If it is determined 330 that sufficient growth has not occurred, the user may continue to incubate 325 the plated combination and/or complete additional steps. Specific examples of additional steps may include addition of surfactants, addition of growth medium, redepositing the microbes and/or the membrane on a new media plate, and/or the like.

If it is determined 330 that sufficient growth has occurred, the user may determine 335 whether any lateral growth has occurred. Determination 335 of whether lateral growth has occurred may include determining whether growth of the microbes has occurred outside any desired areas. For example, if lateral growth has caused the microbes to grow over a portion of the permeable membrane not intended to have microbe growth, it may be determined 335 that lateral growth has occurred. In some embodiments, a minimal amount of growth over the permeable membrane not intended to have microbe growth may be determined 335 that no lateral growth has occurred. Specific minimal amounts of growth may include lateral growth from the desired areas of about 10 microns, about 15 microns, about 20 microns, or any value or range between any of these values. In other embodiments, any growth, no matter how miniscule, over the permeable membrane not intended to have microbe growth may be determined 335 to be lateral growth.

If the user determines 335 that lateral growth has occurred, one or more optional steps may be taken to reduce and/or eliminate the lateral growth. In various embodiments, the user may apply 340 a vacuum to the permeable membrane. In some embodiments, the vacuum may be applied 340 to the surface of the permeable membrane that is opposite the surface containing the microbial growth during printing, so that the printed material flows through the permeable membrane rather than spreading laterally. In various embodiments, the user may adjust 345 the pH of the one or more microbial nutrients contained on the media plate and/or adjust the concentration of the microbial nutrients contained on the media plate. In some embodiments, the user may adjust 345 the pH by increasing the pH so that it is more basic to hinder lateral microbial growth. In some embodiments, the user may adjust 345 the pH by decreasing the pH so that it is more acidic to hinder lateral microbial growth. In some embodiments, the user may adjust 345 the concentration by increasing the concentration of nutrients to hinder lateral microbial growth. In some embodiments, the user may adjust 345 the concentration of nutrients by decreasing the concentration to hinder lateral microbial growth. In various embodiments, the user may adjust 345 the pH and/or the concentration as many times as necessary to impede the lateral growth of the microbes.

Once it has been determined 335 that no undesired lateral growth or an acceptable minimum lateral growth has occurred, the user may remove 350 the film containing the permeable membrane and the microbes from the media plate and dry 355 the film. In some embodiments, the user may dry 355 the film by placing it in an oven. In other embodiments, the user may dry 355 the film by applying a reduced pressure or freeze drying the film. In various embodiments, the user may also apply 360 additional compounds to the film. In some embodiments, the additional compounds may be applied 360 to increase the structural integrity and/or a dimensional stability of the film. In some embodiments, the additional compounds may be applied 360 to make the film rigid. In some embodiments the additional compounds may be applied 360 to prevent the film from degrading when used to complete 365 additional lithographic steps. Specific examples of other compounds that may be applied to the film may include, for example, aluminum oxide, silicon oxide, and silicon nitride. Specific examples of additional lithographic steps may include using the film as a stamp, transferring a pattern on the film to a stamp, and replicating the pattern on the film for use in lithography. The specific examples listed herein are merely illustrative, and other lithographic steps are also contemplated without departing from the scope of this disclosure.

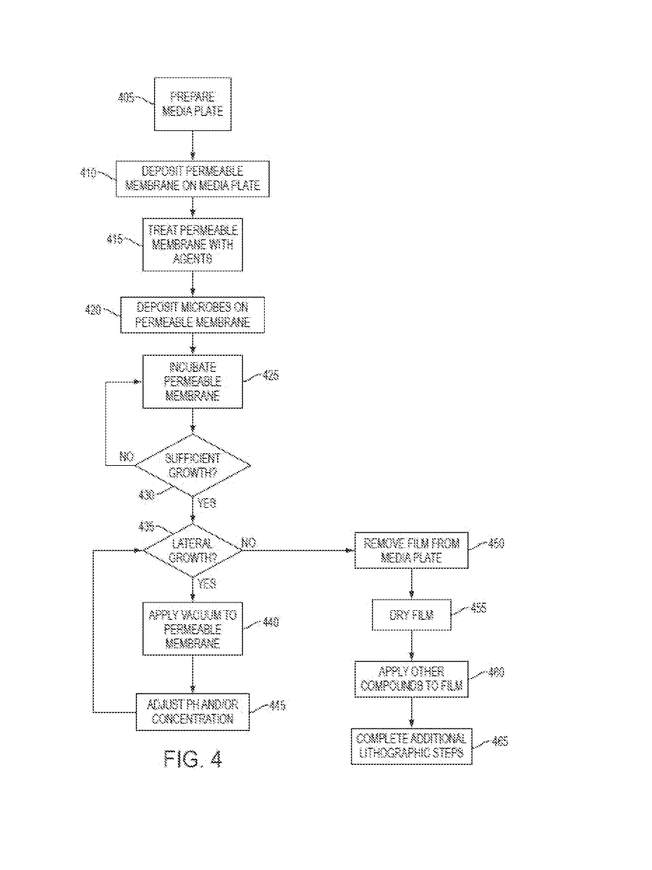

FIG. 4 depicts a flow diagram of an alternative method for creating a master according to an embodiment. The method described herein is merely illustrative; additional, fewer, and/or alternative processes are contemplated without departing from the scope of the present disclosure. The processes described herein will be described with respect to a user; however, more than one user and/or one or more machines may also conduct the processes.

In various embodiments, the user may prepare 405 a media plate and deposit 410 a permeable membrane on the media plate, as described in greater detail herein. The user may treat 415 the permeable membrane with one or more agents. Specific examples of agents may include a pore blocking agent and an antimicrobial agent. In some embodiments, the user may treat 415 the entire permeable membrane with the one or more agents. In other embodiments, the user may treat 415 only a portion of the permeable membrane with the one or more agents. In particular embodiments, the user may treat 415 only the portion of the permeable membrane with a pattern of the one or more agents where microbial growth is not desired. In some embodiments, treatment 415 of the one or more agents may be completed with a printer using an ink formulation containing at least the one or more agents, as described in greater detail herein.

In various embodiments, the user may deposit 420 the microbes on the permeable membrane. In some embodiments, the user may deposit 420 the microbes on the whole permeable membrane. In other embodiments, the user may deposit 420 the microbes on only a portion of the permeable membrane. In particular embodiments, the user may deposit 420 the microbes on the portion of the permeable membrane in which microbe growth is desired, such as, for example, those portions of the permeable membrane that are not treated with the one or more agents. Deposition 420 of the microbes in this manner may allow for the microbes to grow upon the permeable membrane in a desired pattern.

In various embodiments, the user may incubate 425 the plated combination and determine 430 whether sufficient growth has occurred, as described in greater detail herein. If sufficient growth has not occurred, the user may continue to incubate 425 the plated combination and/or complete additional steps. Specific examples of additional steps may include addition of surfactants, addition of growth medium, redepositing the microbes and/or the membrane on a new media plate, and/or the like.

If the user determines 430 that sufficient growth has occurred, the user may also determine 435 whether any lateral growth has occurred, as described in greater detail herein. If lateral growth has occurred, the user may apply 440 a vacuum to the permeable membrane and/or adjust 445 the pH and/or the concentration of the microbial nutrients, as described in greater detail herein.

If the user determines 435 that no undesired lateral growth exists, or that an acceptable minimum lateral growth exists, the user may remove 450 the film from the media plate, dry 455 the film, apply 460 other compounds to the film, and/or complete 465 other lithographic steps, as described in greater detail herein.

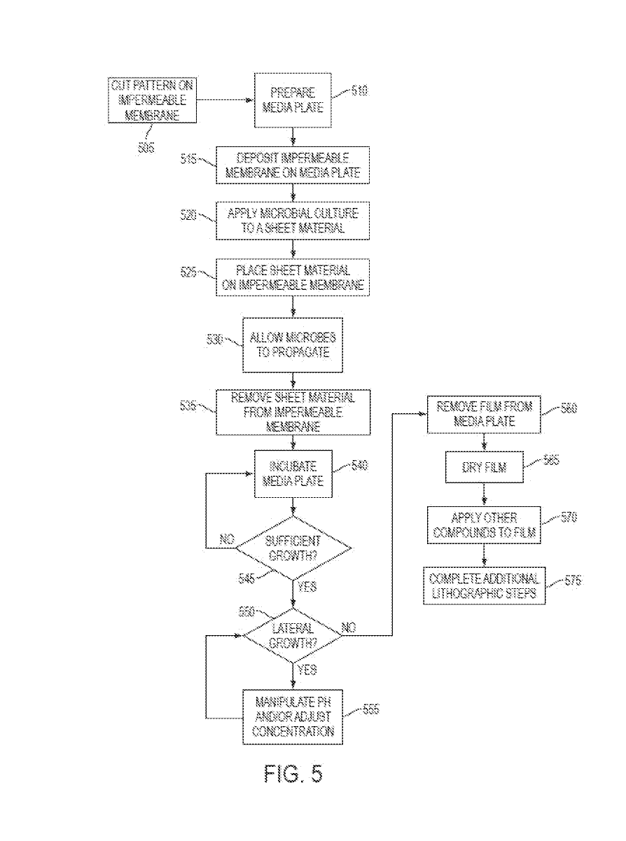

FIG. 5 depicts a flow diagram of another alternative method for creating a master according to an embodiment. The method described herein is merely illustrative; additional, fewer, and/or alternative processes are contemplated without departing from the scope of the present disclosure. The processes described herein will be described with respect to a user; however, more than one user and/or one or more machines may also conduct the processes.

In various embodiments, the user may cut 505 a desired pattern on an impermeable membrane, such as an impermeable thin sheet and/or the like. In some embodiments, the desired pattern may correspond to a desired pattern of microbial growth. In other embodiments, the desired pattern may correspond to a pattern that is complementary to a desired pattern of microbial growth. In some embodiments, the user may cut 505 the desired pattern with a laser cutting device. Specific examples of the impermeable membrane may include one or more of a masking film, a rubylith sheet, an aluminum sheet, a copper sheet, a steel sheet, a brass sheet, an acrylic sheet, and a sheet of polyethylene terephthalate.

In various embodiments, the user may prepare 510 a media plate having at least one or more microbial nutrients, as described in greater detail herein. The user may deposit 515 the impermeable membrane on the media plate, as described in greater detail herein.

In various embodiments, the user may apply 520 a microbial culture to a sheet material. The sheet material may be any material now known or later developed that is capable of supporting microbial growth and or transferring the microbial culture to other materials. One such specific example of a sheet material may be a regenerated cellulose membrane. The sheet material with the microbial culture may then be placed 525 on an impermeable membrane and the microbes may be allowed 530 to propagate from the sheet material on the media plate.

In various embodiments after a period of time has elapsed, the sheet material may be removed 535 from the impermeable membrane so that the microbes remain on the media plate. The period of time is not limited by this disclosure, and may generally be any period of time that is suitable for propagation. Specific examples of the period of time may include about 1 minute, about 2 minutes, about 3 minutes, about 5 minutes, about 10 minutes, about 15 minutes, about 20 minutes, about 30 minutes, about 45 minutes, or about an hour.

In various embodiments, the media plate may be incubated 540 to allow the microbes to grow on the media, as described in greater detail herein. In some embodiments, the microbes may grow on the media in areas that are exposed and not covered by the impermeable membrane. In some embodiments, the microbes may not grow on the media in areas that are covered by the impermeable membrane. The user may determine 545 whether sufficient growth has occurred, as described in greater detail herein. If sufficient growth has not occurred, the user may continue to incubate 540 the media plate and/or complete additional steps. Specific examples of additional steps may include addition of surfactants, addition of growth medium, redepositing the microbes and/or the membrane on a new media plate, and/or the like.

If the user determines 545 that sufficient growth has occurred, then the user may determine 550 whether there is any lateral growth. If lateral growth has occurred, the user may manipulate 555 and/or adjust the concentration of the microbial nutrients, as previously described in greater detail herein. If no lateral growth has occurred or if an acceptably minimal amount of lateral growth has occurred, the user may remove 560 the film from the media plate, dry 565 the film, apply 570 other compounds to the film, and/or complete 575 additional lithographic steps, as described in greater detail herein.

### EXAMPLES

### Example 1

### E. coli Microbes Grown on PVDF

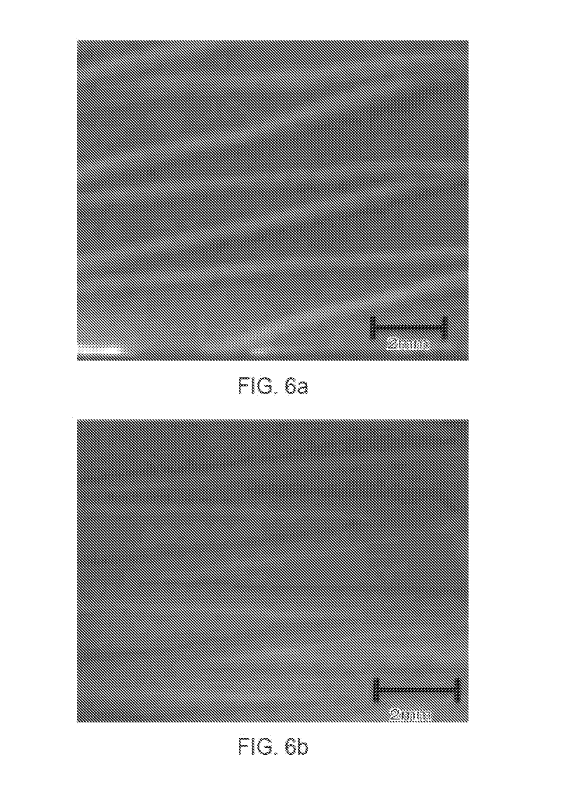

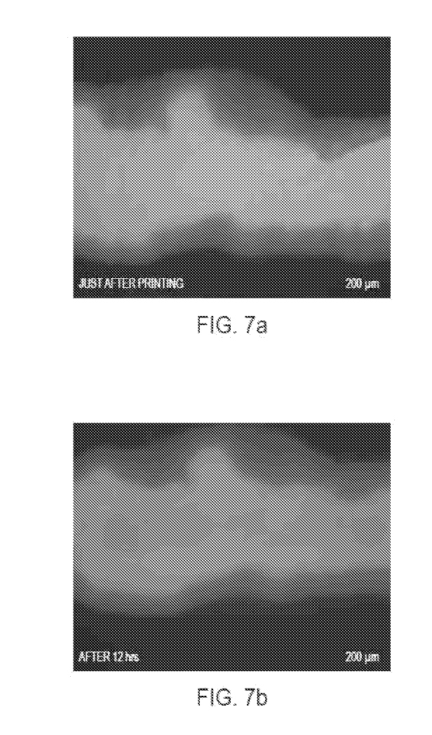

Two media plates containing growth medium suitable for E. coli cultures were prepared, and each plate had a polyvinylidene fluoride (PVDF) membrane. The first plate had a PVDF membrane treated with Tween®-20 (0.1%). The second plate had a PVDF membrane treated with Triton™ X-100 (0.1%). The PVDF membrane was then streaked with E. coli manually using a sterilized loop dipped in E. coli culture and incubated to allow for sufficient growth on the PVDF membrane, but not on the remainder of the media plate. The membrane was then delaminated from the media plate and dried, which resulted in the pattern shown in FIGS. 6a (Tween®-treated PVDF membrane) and 6b (Triton™-treated PVDF membrane). The pattern will then be replicated to create a plurality of identical stamps for micro contact printing.

Example 2

### Printing Surfactants

Various S. cerevisiae cultures were plated on media plates containing a PVDF membrane in a specific pattern, as described in Example 1. Then surfactants were printed on the membrane so that the S. cerevisiae cultures would only grow where the surfactants modified the membrane surface. The surfactants were printed with a Dimatix™ printer (Fujifilm USA, Santa Clara, Calif.) having an ink formulation with a surface tension of about 28 mN/m to about 32 mN/m and a viscosity of about 8 cP to about 12 cP. The surface tension was varied depending on the treatment used on the membrane, as shown in the table below:

| Concentration (Vol % | Tween ®-20 | Triton ™ X-l00 |
|---|---|---|
| in water) | (mN/m) | (mN/m) |
| 1% | 37.50 | 34.24 |
| 10% | 35.56 | 33.39 |
| 20% | 34.76 | 32.66 |

As the concentration was increased, surface tension decreased approaching the desired value of 32 mN/m. The desired value was determined to be 32 mN/m because it is a value that is suitable for printer use. However, the viscosity increased to a value that was much larger than acceptable for this particular Example. As a result, a mixture containing both surfactants was tried. The mixture had a 10% Tween®-20 concentration and a 10% Triton™ X-100 concentration. The ink containing the surfactants and the S. cerevisiae cells was placed in a printer and deposited over the PVDF membrane, which caused the S. cerevisiae cells to only grow in the areas containing the surfactants, as depicted by the images in FIG. 7.

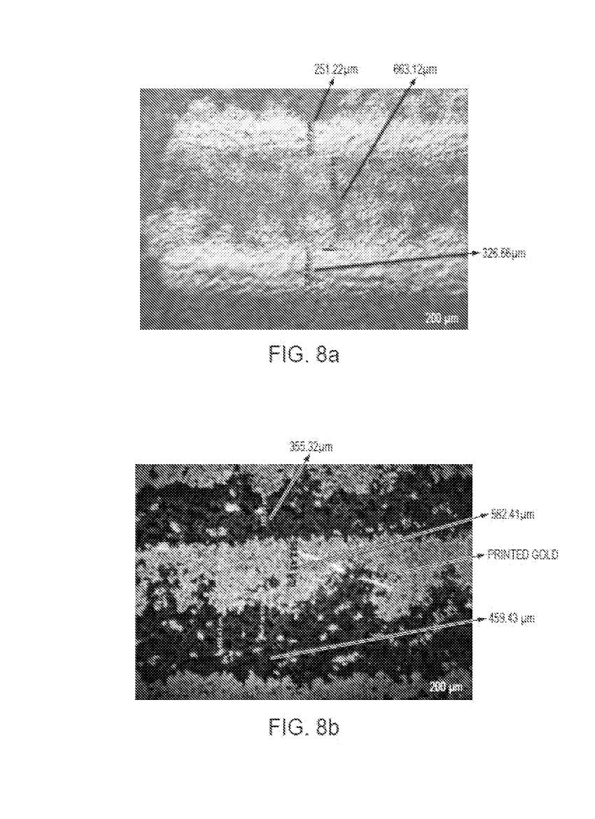

After sufficient growth, the cultures were dried in an oven at 87° C. for 2-3 hours and then coated with PDMS. After curing, the PDMS stamp was used for contact printing of a colloidal solution of gold nanoparticles on Si/SiO₂. The final gold patterns obtained from the stamp are shown in FIG. 8. The PDMS stamp had a raised portion of 663.12 μm and recessed portions of 251.22 μm and 326.66 μm. The final gold patterns had a feature size of 582.41 μm, which corresponded to the raised portion of the stamp and thus the spacing between the yeast patterns.

### Example 3

### Laser Cutting

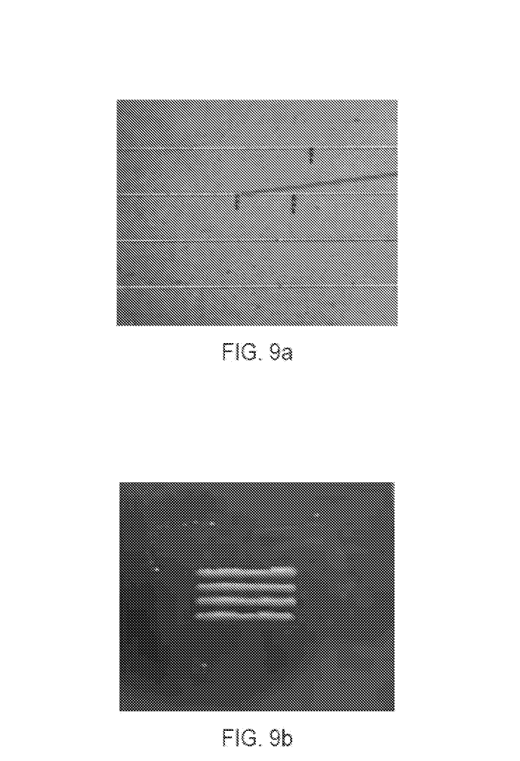

Rubylith film (Ulano Corporation, Brooklyn, N.Y.), a masking film consisting of two layers that resists microbial growth, was used as a substrate. The bottom layer of the Rubylith film is a clear polyester sheet and the top layer is a translucent, red-colored, self-adhesive emulsion that is generally used in photolithography. A pattern was cut into the Rubylith film with a resolution of 10-20 microns through the use of a yttrium vanadate green laser (λ=532 nm), as shown in FIG. 9a. When plated on a nutrient media plate and inoculated with S. cerevisiae cultures, the cultures only grew at the location of the cuts where the nutrient media was exposed below. The resultant growth is shown in FIG. 9b.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A method of creating a master for micro contact printing, the method comprising:
depositing a permeable membrane on a surface of a media plate comprising one or more microbial nutrients;
depositing a plurality of microbes upon the permeable membrane, wherein the plurality of microbes are configured to grow away from the permeable membrane in a vertical direction to form a patterned surface; and
treating at least a portion of the permeable membrane with one or more surfactants by selectively placing the one or more surfactants upon the permeable membrane in a desired pattern.

2. (canceled)

3. The method of claim 1, wherein the treating and the depositing are completed substantially concurrently with a mixture comprising the one or more surfactants and the plurality of microbes.

4. The method of claim 1, wherein treating at least the portion of the permeable membrane comprises printing the one or more surfactants onto the permeable membrane with a printer.

5. The method of claim 4, wherein the printer is one or more of an inkjet printer, a screen printer, an off-set printer, and a precision materials deposition printer.

6. The method of claim 4, further comprising supplying the printer with an ink formulation comprising the one or more surfactants.

7. The method of claim 1, wherein the one or more surfactants comprise one or more of a nonionic surfactant, an anionic surfactant, a cationic surfactant, a zwitterionic surfactant, and a polysorbate surfactant.

8. The method of claim 1, further comprising minimizing lateral growth of the plurality of microbes over a portion of the permeable membrane that does not contain the surfactant by one or more of applying a vacuum to a first surface of the permeable membrane that is opposite a second surface of the permeable membrane being treated with the surfactant, manipulating the pH of the one or more microbial nutrients, and diluting the concentration of the one or more microbial nutrients.

9. (canceled)

10. The method of claim 1, wherein the plurality of microbes are configured to grow in a controlled manner on the permeable membrane.

11. The method of claim 1, wherein the vertical growth of the plurality of microbes has an average height of about 10 microns to about 1000 microns.

12. The method of claim 1, further comprising:
incubating the plurality of microbes;
removing a film comprising the permeable membrane and the plurality of microbes from the media plate comprising the one or more microbial nutrients; and
drying the film.

13.-14. (canceled)

15. The method of claim 1, wherein the plurality of microbes comprise one or more of a culturable cell, an adherent cell, a neoplastic cell, a neuronal cell, a microglia cell, a giant cell, a hormone secreting cell, a metabolism cell, a storage cell, a barrier function cell, an extracellular matrix-secreting cell, a contractile cell, a blood and immune system cell, a germ cell, a stem cell, a fused cell, a primary cell, a cell line, a bacterial cell, a yeast, and a protist.

16. The method of claim 1, wherein the plurality of microbes comprise one or more of Escherichia coli, Saccharomyces cerevisiae, Saccharomyces exiguus, and a biofilm bacterium.

17. The method of claim 1, wherein the permeable membrane comprises one or more of polyvinylidene fluoride, regenerated cellulose, nitrocellulose, cellophane, polymethylmethacrylate, nylon, cellulose acetate, cellulose ester, benzoylated cellulose, and polysulphone.

18. The method of claim 1, wherein the permeable membrane comprises a pore size of about 3 kDa to about 100 kDa.

19.-40. (canceled)

41. A method of creating a master for micro contact printing, the method comprising:
cutting a desired pattern on an impermeable thin sheet;
placing the impermeable thin sheet on a surface of a media plate comprising one or more microbial nutrients; and
depositing a mixture comprising a plurality of microbes on the impermeable thin sheet, wherein the plurality of microbes are configured to grow away from the surface of the media plate in a vertical direction through the patterned cuts in the impermeable thin sheet to form a patterned surface.

42. The method of claim 41, wherein depositing the mixture comprising the plurality of microbes on the impermeable thin sheet further comprises:
applying a microbial culture comprising the plurality of microbes to a sheet;
placing the sheet on the impermeable thin sheet; and
removing the sheet from the impermeable thin sheet after a period of time.

43. The method of claim 42, wherein the sheet comprises a regenerated cellulose membrane.

44. The method of claim 42, wherein the period of time comprises about 1 minute to about one hour.

45. The method of claim 41, wherein the vertical growth of the plurality of microbes extends to an average height of about 10 microns to about 1000 microns above a top surface of the impermeable thin sheet.

46. The method of claim 41, further comprising minimizing a lateral growth of the plurality of microbes over a portion of a top surface of the impermeable thin sheet by one or more of manipulating the pH of the one or more microbial nutrients and diluting the concentration of the one or more microbial nutrients.

47. The method of claim 41, further comprising incubating a combination comprising the media plate, the impermeable thin sheet, and the mixture.

48. The method of claim 47, further comprising one or more of using the combination as a stamp, applying polydimethyl siloxane to the combination, applying gold nanoparticle ink to the combination, transferring a pattern on the combination to a stamp, and replicating the pattern on the combination.

49. The method of claim 41, wherein the plurality of microbes comprise one or more of a culturable cell, an adherent cell, a neoplastic cell, a neuronal cell, a microglia cell, a giant cell, a hormone secreting cell, a metabolism cell, a storage cell, a barrier function cell, an extracellular matrix-secreting cell, a contractile cell, a blood and immune system cell, a germ cell, a stem cell, a fused cell, a primary cell, a cell line, a bacterial cell, a yeast, and a protist.

50. The method of claim 41, wherein the plurality of microbes comprise one or more of Escherichia coli, Saccharomyces cerevisiae, Saccharomyces exiguus, and a biofilm bacterium.

51. The method of claim 41, wherein the impermeable thin sheet comprises one or more of a masking film, a rubylith sheet, an aluminum sheet, a copper sheet, a steel sheet, a brass sheet, an acrylic sheet, and a sheet of polyethylene terephthalate.

52.-60. (canceled)
